(19) United States
(12) Patent Application Publication
(10) Pub. No.: US 2017/0339022 A1
(43) Pub. Date: Nov. 23, 2017

(54) ANOMALY DETECTION AND PREDICTION IN A PACKET BROKER

(71) Applicant: Brocade Communications Systems, Inc., San Jose, CA (US)

(72) Inventors: Deepak Hegde, Bangalore (IN); Shailender Sharma, Bangalore (IN); Jude Pragash Vedam, Bangalore (IN); Ashwin Naresh, Bangalore (IN)

(21) Appl. No.: 15/466,732

(22) Filed: Mar. 22, 2017

(30) Foreign Application Priority Data
May 17, 2016 (IN) 201641016960

(51) Int. Cl. H04L 12/24; H04L 12/26; G06N 99/00

(52) U.S. Cl. CPC H04L 41/147; G06N 99/005; H04L 43/04

(57) ABSTRACT

Techniques for performing anomaly detection and prediction in a packet broker of a visibility network are provided. According to one embodiment, the packet broker can apply one or more machine learning models to network traffic that is replicated from a core network. The packet broker can further detect or predict, based on the application of the one or more machine learning models, the occurrence of a network traffic anomaly in the core network. The packet broker can then take one or more predefined actions in response to the detection/prediction of the anomaly.

### CROSS-REFERENCES TO RELATED APPLICATIONS

The present application claims the benefit and priority of India Provisional Application No. 201641016960, filed May 17, 2016, entitled “NETWORK LEARNING IN A VISIBILITY FABRIC.” The entire contents of this application are incorporated herein by reference in its entirety for all purposes.

### BACKGROUND

In the field of computer networking, a visibility network (also known as a “visibility fabric”) is a type of network that facilitates the monitoring and analysis of traffic flowing through another, “core” network (e.g., a production network). The reasons for deploying a visibility network are varied and can include network management and optimization, business intelligence/reporting, compliance validation, service assurance, security monitoring, and so on.

FIG. 1 depicts an example visibility network 100 according to an embodiment. As shown, visibility network 100 includes a number of taps 102 that are deployed within a core network 104. Taps 102 are configured to replicate data and control traffic that is exchanged between network elements in core network 104 and forward the replicated traffic to a packet broker 106 (note that, in addition to or in lieu of taps 102, one or more routers or switches in core network 104 can be tasked to replicate and forward data/control traffic to packet broker 106 using their respective SPAN or mirror functions). Packet broker 106 can perform various packet processing functions on the replicated traffic, such as removing protocol headers, filtering/classifying packets based on configured rules, and so on. Packet broker 106 can then forward the processed traffic to one or more analytic probes/tools 108, which can carry out various calculations and analyses on the traffic in accordance with the business goals/purposes of visibility network 100 (e.g., calculation of key performance indicators (KPIs), detection of traffic anomalies, generation of reports, etc.).

In cases where analytic probes/tools 108 are configured to perform traffic anomaly detection, existing implementations of these probes/tools generally follow an approach that involves (1) recording/storing all of the traffic data replicated from core network 104 (i.e., both anomalous and non-anomalous traffic data), and (2) subsequently performing a post-hoc analysis on the stored data in order to identify anomalies. While this approach is functional, it also suffers from a number of inefficiencies and drawbacks. For example, consider a scenario where core network 104 is a very high volume network such as, e.g., a mobile service provider network. In this case, the amount of compute and storage resources needed on analytic probes/tools 108 in order to store and analyze all of the traffic replicated from core network 104 will also be very high (even though only a small percentage of that traffic may actually be anomalous), resulting in significant infrastructure costs and poor scaling of visibility network 100 as the scope of core network 104 grows.

Further, the post-hoc analysis described above is typically performed long after the anomalies being detected have occurred in core network 104. This makes it difficult or impossible for analytic probes/tools 108 to implement measures that address the root causes of the anomalies while they are in progress, or to actively predict the occurrence of future anomalies.

### SUMMARY

Techniques for performing anomaly detection and prediction in a packet broker of a visibility network are provided. According to one embodiment, the packet broker can apply one or more machine learning models to network traffic that is replicated from a core network. The packet broker can further detect or predict, based on the application of the one or more machine learning models, the occurrence of a network traffic anomaly in the core network. The packet broker can then take one or more predefined actions in response to the detection/prediction of the anomaly.

The following detailed description and accompanying drawings provide a better understanding of the nature and advantages of particular embodiments.

### BRIEF DESCRIPTION OF DRAWINGS

FIG. 1 depicts an example visibility network.

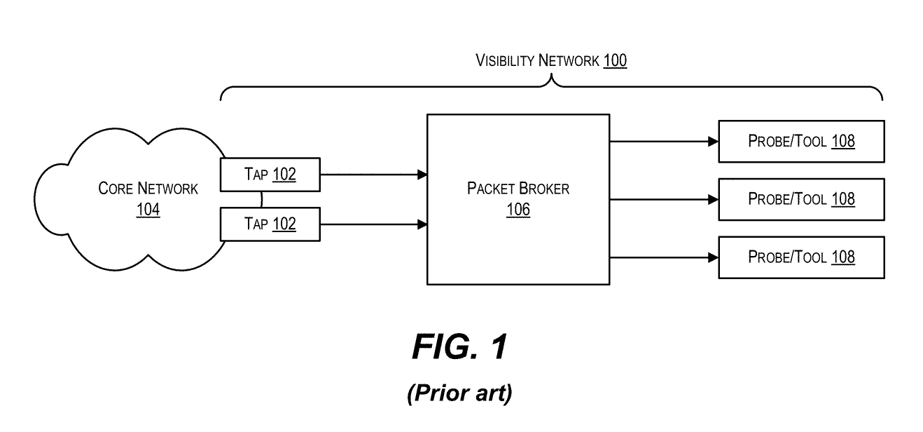

FIG. 2 depicts a visibility network in which the anomaly detection/prediction techniques of the present disclosure may be implemented according to an embodiment.

FIG. 3 depicts a workflow for training a machine learning model used for anomaly detection/prediction according to an embodiment.

FIG. 4 depicts an example LSTM neural network according to an embodiment.

FIG. 5 depicts a workflow for performing anomaly detection according to an embodiment.

FIG. 6 depicts a workflow for performing anomaly prediction according to an embodiment.

FIG. 7 depicts an example user interface for a core network visualization tool according to an embodiment.

FIG. 8 depicts an example network device according to an embodiment.

FIG. 9 depicts an example computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure provide techniques that can be implemented by a packet broker in a visibility network for detecting and predicting anomalies in the network traffic of a core network. In one set of embodiments, these techniques can include training, by the packet broker based on traffic data replicated from the core network, one or more machine learning models that are designed to model the core network's typical traffic patterns. For instance, one such machine learning model can be designed to model changes in the value of a particular core network parameter over time (e.g., subscriber attach rate, paging rate, data throughput, etc.).

Once the machine learning models have been trained, the packet broker can apply these models (and/or other pre-trained models) to subsequent traffic that is replicated from the core network in order to detect and/or predict the occurrence of traffic anomalies in the core network in real-time. For example, in the case where the packet broker has trained a machine learning model M that models subscriber attach rate, the packet broker can compare the current subscriber attach rate in the core network with the subscriber attach rate value modeled by M for the current point in time. If the difference between these two values exceeds a threshold, the packet broker can determine that an anomaly with respect to subscriber attach rate has occurred (or is in the process of occurring). Alternatively or in addition, the packet broker can compare an extrapolated future subscriber attach rate in the core network modeled by M with a predefined threshold. If the extrapolated future value exceeds the threshold, the packet broker can predict that an anomaly with respect to subscriber attach rate will very likely occur in the future.

Then, upon determining that a traffic anomaly has occurred or will soon occur in the core network, the packet broker can take one or more predefined (e.g., user-defined) actions. These predefined actions can include applying a filter that steers replicated traffic related to the anomalous event (e.g., traffic originating from a particular location or associated with a particular host/subscriber) to one or more special analytic probes/tools for further analysis and storage. The predefined actions can also include, e.g., generating an alert for a network administrator, implementing metering or sampling of the replicated traffic (in the case of an anomalous traffic burst), and others.

With the general approach described above, a number of benefits can be realized over prior art techniques that implement anomaly detection in a post-hoc fashion on the analytic probes/tools of the visibility network. First, by moving the anomaly detection task from the analytic probes/tools to the packet broker, the packet broker can advantageously steer only anomalous (or likely to be anomalous) traffic to the probes/tools, which will typically make up a small percentage of the overall traffic replicated from the core network. This means that the computational and storage resources needed on the analytic probes/tools can be significantly reduced, which in turn can allow these components to scale out and handle very large traffic volumes in the core network in an efficient manner.

Second, since the packet broker monitors for anomalies in a real-time manner, in certain embodiments the packet broker can actively predict the occurrence of future anomalies and take steps to address them. For example, the packet broker may forward a traffic flow associated with a predicted future anomaly to the analytic probes/tools for preemptive analysis and review, before the anomaly actually occurs.

Third, by performing anomaly detection and prediction using various different machine learning models, the packet broker can flexibly and accurately detect/predict a large number of different anomalies. For example, as mentioned above, the packet broker may apply one set of machine learning models (referred to herein as “time-series models”) to detect/predict anomalies in time-series traffic data, such as subscriber attach rate, paging rate, data throughput, etc., derived from the core network. The packet broker may also apply another set of machine learning models (referred to herein as “protocol language models”) to detect/predict anomalies in protocol message exchanges/flows replicated from the core network. The particular machine learning models that are in use at any point in time, as well as the specific detection/prediction rules that are applied for each model, may be configurable by a network administrator.

These any other aspects of the present disclosure are described in further detail below.

### 2. Visibility Network

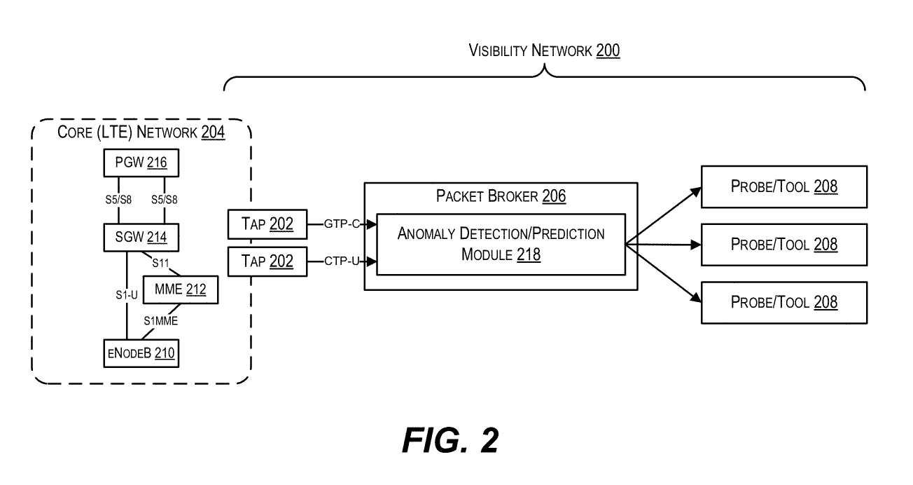

FIG. 2 depicts a visibility network 200 that may be used to implement the anomaly detection/prediction techniques of the present disclosure according to an embodiment. As shown, visibility network 200 includes a number of taps 202 that are deployed in a core network 204 and are configured to replicate traffic exchanged in network 204 to a packet broker 206. In FIG. 2, core network 204 is a mobile LTE network that comprises network elements specific to this type of network, such as an eNodeB 210, a mobility management entity (MME) 212, a serving gateway (SGW) 214, and a packet data network gateway (PGW) 216 which connects to an external packet data network such as the Internet. Further, in this particular example, taps 202 are configured to replicate and forward GTP-C and GTP-U traffic that is exchanged on certain interfaces of core network 204. However, it should be appreciated that core network 204 can be any other type of computer network known in the art, such as a mobile 3G network, a landline local area network (LAN) or wide area network (WAN), etc.

Upon receiving the replicated traffic via taps 202, packet broker 206 can perform various types of packet processing functions on the traffic (as configured/assigned by an operator of visibility network 200) and can forward the processed traffic to one or more analytic probes/tools 208 for analysis. In one embodiment, packet broker 206 can be implemented solely in hardware, such as in the form of a network switch or router that relies on ASIC or FPGA-based packet processors to execute its assigned packet processing functions based on rules that are programmed into hardware memory tables (e.g., CAM tables) resident on the packet processors and/or line cards of the device. In another embodiment, packet broker 206 can be implemented solely in software that runs on, e.g., one or more general purpose physical or virtual computer systems. In yet another embodiment, packet broker 206 can be implemented using a combination of hardware and software, such as a combination of a hardware-based basic packet broker and a software-based “session director” cluster as described in co-owned U.S. patent application Ser. No. 15/205,889, entitled “Software-based Packet Broker,” the entire contents of which are incorporated herein by reference in its entirety for all purposes.

As noted in the Background section, in cases where analytic probes/tools 208 are tasked with detecting traffic anomalies in core network 204, conventional implementations of these probe/tools record and store all of the traffic replicated from core network 204 and perform a post-hoc analysis on the stored data. However, this approach suffers from a number of inefficiencies and limitations, such as heavy investment cost for probes/tools 208 in scenarios where core network 204 generates high volumes of traffic, inability to address and predict anomalies in real-time, and so on.

To address these and other similar issues, packet broker 206 of FIG. 2 is enhanced to include a novel anomaly detection/prediction module 218. Depending on the configuration of packet broker 206, anomaly detection/prediction module 218 can be implemented in software, hardware, or a combination thereof. At a high level, anomaly detection/prediction module 218 can (1) train one or more machine learning models that are designed to model core network 204's traffic patterns (and thereby learn the typical behavior of core network 204); (2) apply the trained (as well as other pre-trained) machine learning models to subsequent traffic that is replicated from core network 204 in order to detect and/or predict the occurrence of traffic anomalies in core network 204 in real-time; and (3) upon detecting or predicting an anomaly, execute one or more predefined actions, such as steer replicated traffic that is deemed to be associated with the anomaly to a particular analytic probe/tool 208 for storage and further analysis. In this way, anomaly detection/prediction module 218 can eliminate or minimize many of the problems associated with conventional post-hoc anomaly detection on analytic probes/tools 208. The details for implementing the training, detection, and prediction steps above are described in the sections that follow.

It should be appreciated that FIG. 2 is illustrative and not intended to limit embodiments of the present disclosure. For example, the various entities shown in FIG. 2 may be arranged according to different configurations and/or include subcomponents or functions that are not specifically described. One of ordinary skill in the art will recognize other variations, modifications, and alternatives.

### 3. Model Training Workflow

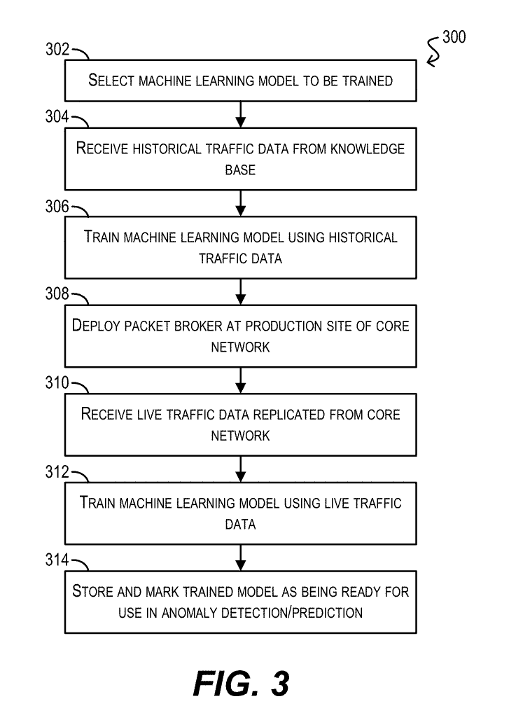

FIG. 3 depicts a workflow 300 that can be executed by anomaly detection/prediction module 218 of packet broker 206 for training a machine learning model that will be used for detecting/predicting traffic anomalies in core network 204 according to an embodiment. Generally speaking, training workflow 300 will be applied to machine learning models that model traffic patterns/behavior which may differ from one network to another (and thus benefit from learning the specific patterns/behavior of a specific core network). Examples of such machine learning models include time-series models that track changes in the values of certain core network data or signaling parameters (e.g., subscriber attach rate, paging rate, packets per second, etc.) over time. Training workflow 300 does not need to be applied to machine learning models that model traffic patterns/behavior which will be substantially similar across different deployments, such as protocol language models.

Starting block 302, module 218 can first select a machine learning model to be trained for anomaly detection/prediction. In one set of embodiments, the manufacturer/vendor of packet broker 206 can pre-install a number of different machine learning models for this purpose on packet broker 206 and module 218 can select one of the pre-installed models. In these cases, the pre-installed models may be pre-trained by the manufacturer/vendor using generic training data so that they have an initial “base state” to work from (which can shorten the time needed to complete training workflow 300). In other embodiments, the user/customer operating packet broker 206 may define and supply their own pre-trained or not-pre-trained machine learning model as part of block 302.

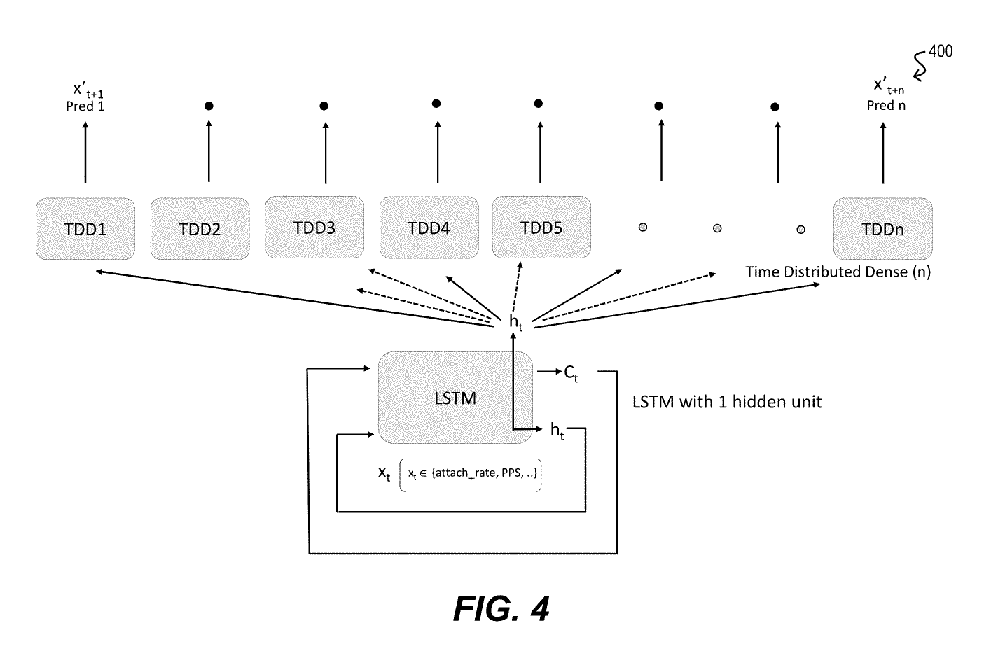

As mentioned previously, the machine learning model that is selected for training will generally be one that benefits from learning the specific traffic patterns and behaviors of core network 204, such as a time-series model that learns time-series data from the core network. There are a number of different machine learning algorithms and constructs that can be used for implementing a time-series model, such as a Long Short Term Memory (LSTM) neural network. In the specific case of a LSTM neural network, the network can learn the “normal” behavior of a given parameter x over time and, once trained, can output an expected (i.e., modeled) value for this parameter (x′) at n different time points ranging from t (i.e., the current point in time) to t+n. A block diagram of an example LSTM neural network 400 is shown in FIG. 4. Other types of machine learning algorithms/constructs can also be used for time-series based modeling and will be apparent to one of ordinary skill in the art.

Returning to FIG. 3, once the machine learning model is selected, module 218 can carry out a first training phase that involves (1) receiving, from a knowledge base comprising historical traffic logged from core network 204, traffic data regarding the core network parameter modeled by the selected machine learning model (block 304), and (2) training/updating the machine learning model based on the historical traffic data (block 306). For example, if the machine learning model is designed to model subscriber attach rate, module 218 can receive from the knowledge base traffic data indicating how subscriber attach rate changed over some prior period of time in core network 204 and can train the model accordingly. In this way, module 218 can “prime” the machine learning model using traffic data that packet broker 206 will likely receive from the actual, live version of core network 204, without having to insert packet broker 206 into the production environment yet. The volume of historical training data learned during this first training phase can differ depending on the nature of the machine learning model and/or core network 204, and can range from a few days' worth of data to weeks, months, or more.

Upon completion of the first training phase, packet broker 206 can be deployed at the actual, live (i.e., production) site of core network 204 (block 308). Then, at blocks 310 and 312, module 218 can carry out a second training phase that is similar to the first training phase, but trains the machine learning model using live traffic data replicated from core network 204 (rather than historical traffic data received from the knowledge base). In this way, module 218 can refine the machine learning model using real-time traffic data generated at the production site and thereby ensure that the model is as accurate and up-to-date as possible. Like the first training phase, the volume of data learned during this second training phase can vary depending on the nature of the machine learning model and/or core network 204.

Finally, at block 314, module 218 can store the trained machine learning model and mark it as being ready for use in detecting/predicting anomalies in core network 204. In some embodiments, module 218 may also return to block 310 and repeat the second training phase on a continuous or periodic basis in order to keep the machine learning model up-to-date with respect to the ongoing traffic patterns occurring in core network 204.

It should be appreciated that workflow 300 of FIG. 3 is illustrative and various modifications and enhancements are possible. For example, the specific manner and/or order in which the first and training phases are executed may differ on a case-by-case basis. In some cases, the first training phase (based on historical traffic data) may be omitted and module 218 may train the machine learning model solely using live traffic data from core network 204. In other cases, the second training phase may be omitted and module 218 may train the machine learning model solely using historical traffic data from the knowledge base. In yet other cases, both the first and training phases may be executed, but they may be performed concurrently, in a different order, or in an overlapping manner.

Further, although not explicitly shown, module 218 may repeat workflow 300 (or run multiple instances of workflow 300 concurrently) in order to train several different types of machine learning models and/or temporal variations of a single type of model. For example, it is possible that the pattern/behavior of a given core network parameter can change significantly on a day-to-day basis. In this scenario, module 218 may train seven different machine learning models that all relate to the same core network parameter, but apply to different days of the week (e.g., a Monday model variant, a Tuesday model variant, etc.). With this approach, module 218 can subsequently use the appropriate daily model for anomaly detection/prediction based on the current day of the week. One of ordinary skill in the art will recognize other variations, modifications, and alternatives.

### 4. Anomaly Detection Workflow

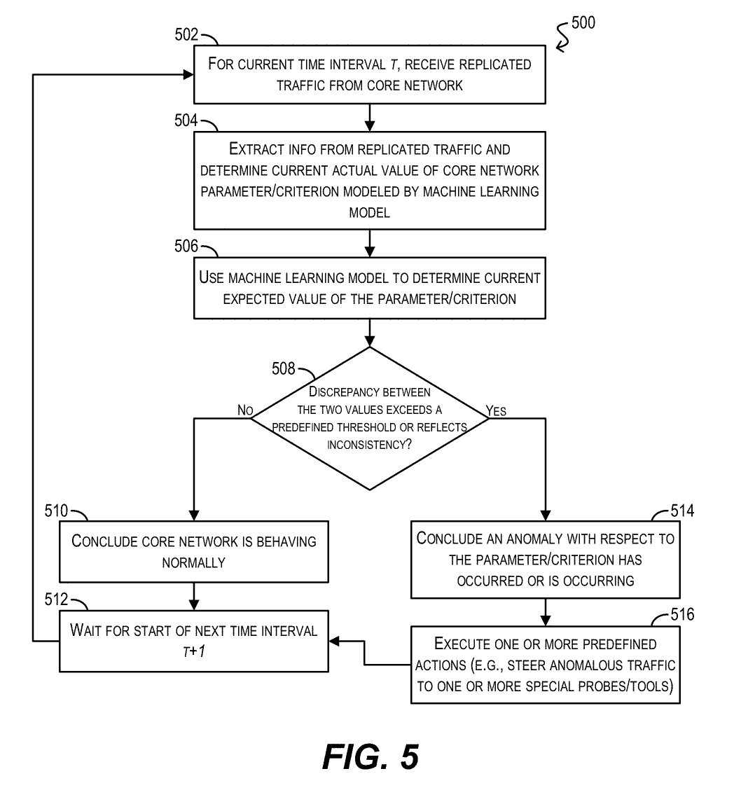

Once anomaly detection/prediction module 218 has access to at least one trained machine learning model (either via training workflow 300 of FIG. 3 or a different pre-training process), module 218 can execute a workflow for performing real-time detection of anomalies in core network 204 using the trained model. FIG. 5 depicts a workflow 500 of this detection process according to embodiment. As noted previously, the trained machine learning model may be a time-series model (which models the value of a core network parameter over time), a protocol language model (which models valid protocol message exchanges and flows), or any other type of machine learning model that is usable for identifying deviations in the normal traffic patterns/behavior of core network 204.

Starting with blocks 502 and 504 of workflow 500, module 218 can, for a current time interval t, receive replicated traffic from core network 204 and can extract information from the replicated traffic that enables module 218 to determine the current actual value of a core network parameter or criterion modeled by the machine learning model. For example, if the machine learning model is a time-series model M1 configured to model the value of a core network parameter x, module 218 can extract information from the replicated traffic that enables module 218 to determine the actual value of x in core network 204 for the current time interval t (i.e., xₜ). Alternatively, if the machine learning model is a protocol language model M2 configured to model valid message exchanges for a given network protocol P, module 218 can extract information from the replicated traffic that enables module 218 to determine the specific message exchanges made using protocol P in the current time interval t.

At block 506, module 218 can use the machine learning model to determine, for the current time interval t, an expected (i.e., modeled) value for the same network parameter or criterion determined at block 504. For example, in the case of time-series model M1 above, module 218 can use M1 to output an expected value for parameter x at time t (i.e., x′ₜ). Alternatively, in the case of protocol language model M2 above, module 218 can use M2 to output an expected message exchange or flow using protocol P at time t.

Once module 218 has determined the actual and expected values of the network parameter or criterion, module 218 can compare the two values and determine whether there is a discrepancy between the two values that exceeds a predefined threshold or reflects a critical inconsistency (block 508). For example, module 218 can determine whether x′ₜ-xₜ exceeds a numerical threshold T, or whether the actual and expected message exchanges are substantially different/out of order/etc. (indicating that the actual message exchange may be invalid).

If the discrepancy between the two values does not exceed the threshold or does not reflect a critical inconsistency, module 218 can conclude that core network 204 is behaving normally (block 510). As a result, module 218 can wait for the start of the next time interval t+1 (block 512) and then return to block 502 in order to repeat the detection process at time t+1.

However, if the discrepancy between the two values does exceed the threshold or does reflect a critical inconsistency, module 218 can conclude that an anomaly with respect to the parameter/criterion has occurred (or is in the progress of occurring) in core network 204 (block 514). In this case, module 218 can execute one or more predefined actions that are associated with the model (block 516). For example, in one embodiment, module 218 can apply a filter that steers all replicated traffic from core network 204 that is deemed to be related to the anomaly (e.g., all traffic from a particular location or a particular host/subscriber) to one or more special analytic probes/tools 208 for storage and further analysis. In this way, module 218 can selectively forward only the traffic that is likely to be of interest for anomaly analysis purposes to those special probes/tools. As part of this steering step, in certain embodiments module 218 can also generate and send metadata information related to the steered traffic (in the form of, e.g., IPFix packets) to the special analytic probes/tools. This metadata information can include, e.g., where the traffic originated from, subscriber/session info, and other contextual cues which the probes/tools can use to facilitate their analysis of the anomalous traffic and help identify the root cause of the anomaly.

In other embodiments, module 218 can execute other actions in addition to (or in lieu of) the traffic steering described above, such as generating an alert for a network administrator, metering further traffic replicated from core network 204, and so on. The specific nature of these actions can be configurable by a user/administrator of packet broker 206.

Finally, once the predefined action(s) have been executed, module 218 can wait for the next time interval t+1 as mentioned previously (block 512) and subsequently return to block 502 in order to repeat the detection process at time t+1.

### 5. Anomaly Prediction Workflow

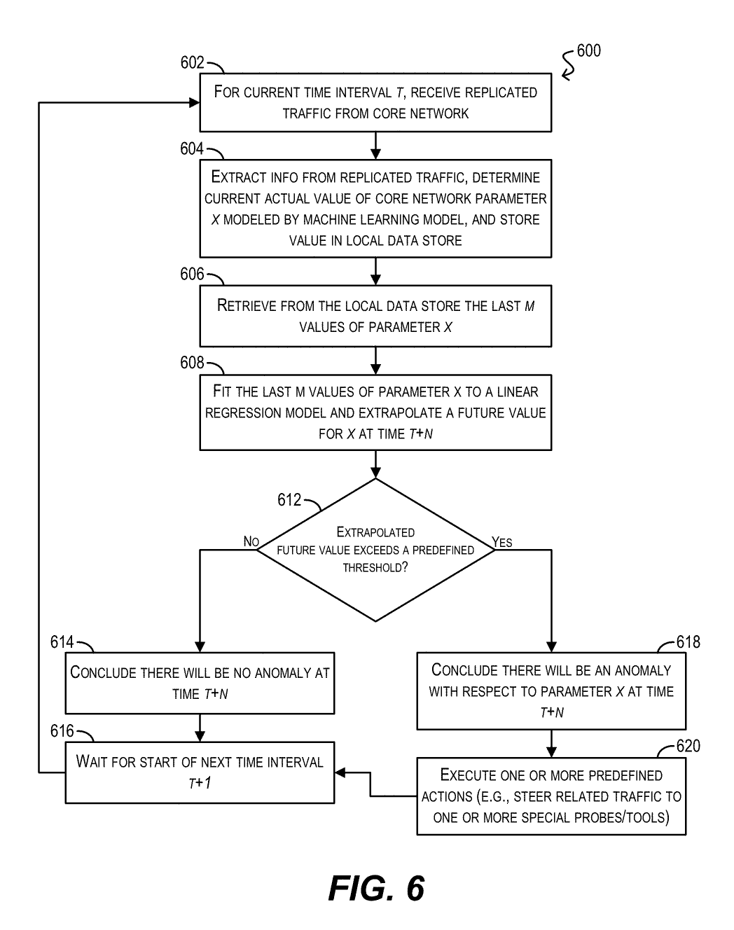

In addition to real-time anomaly detection, module 218 of packet broker 206 can also perform real-time prediction of future anomalies in core network 204 via its trained machine learning model(s). FIG. 6 depicts a workflow 600 illustrating this prediction process according to an embodiment. Workflow 600 assumes that the machine learning model used for anomaly prediction is specifically a time-series model that tracks the value of a core network parameter x over time.

Starting with blocks 602 and 604, module 218 can, for a current time interval t, receive replicated traffic from core network 204, extract information from the replicated traffic that enables module 218 to determine the current value for core network parameter x (i.e., xₜ), and store xₜ in a local data store. Further, at block 606, module 218 can retrieve from the data store the last m values of parameter x (i.e., xₜ₋₁, xₜ₋₂, . . . xₜ₋ₘ).

At block 608, module 218 can fit the m values retrieved at block 606 to a linear regression model in order to extrapolate a value of core network parameter x at some future point in time t+n (i.e., xₜ₊ₙ). Module 218 can then compare the extrapolated value with a predefined threshold T (block 612). This predefined threshold can be different from the threshold discussed with respect to anomaly detection workflow 500.

If the extrapolated future value does not exceed the predefined threshold T, module 218 can conclude that there will be no future anomaly with respect to core network parameter x at time t+n (block 614). As a result, module 218 can wait for the start of the next time interval t+1 (block 616) and subsequently return to block 602 in order to repeat the prediction process at time t+1.

However, if the extrapolated future value does exceed threshold T, module 218 can conclude that an anomaly with respect to parameter x will occur at time t+n in core network 204 (block 618). In this case, module 218 can execute one or more predefined actions that are associated with the model (block 620), such as steering all replicated traffic from core network 204 that is deemed to be related to the anomaly to one or more special analytic probes/tools 208 for storage and further analysis. In this way, the special probes/tools can analyze and potentially implement steps to avoid the anomaly before it actually occurs. Module 218 also execute other actions at block 620 such as generating an administrator alert, dropping/metering the replicated traffic, and so on.

Finally, once the predefined action(s) have been executed, module 218 can wait for the next time interval t+1 as mentioned previously (block 616) and subsequently return to block 602 to repeat the prediction process at time t+1.

It should be appreciated that anomaly detection and prediction workflows 500 and 600 are illustrative and modifications and enhancements are possible. For example, module 218 may repeat or execute multiple instances of these workflows concurrently in order to detect and/or predict different types of anomalies in core network 204 via different machine learning models. Further, module 218 may execute workflow 500 simultaneously with workflow 600 in order to perform anomaly detection and prediction in parallel. One of ordinary skill in the art will recognize other variations, modifications, and alternatives.

### 6. Automated Core Network Discovery

Beyond the anomaly detection and prediction techniques described in the foregoing sections, in certain embodiments packet broker 206 of FIG. 2 may also implement automated discovery of the topology and entities in core network 204. With this automated discovery feature, the configuration of packet broker 206 can be streamlined, since there is no need for an administrator to manually enter information into packet broker 206 regarding core network 204 (e.g., IP addresses, interfaces, etc.). Instead, this configuration can be determined automatically based on the discovered core network entities and topology. Further, this automated discovery feature can enable packet broker 206 to implement new types of traffic filters, such as a filter to steer traffic of a newly detected core network entity to a particular analytic probe/tool, or a filter to drop traffic from portions of core network 204 that are known to carry duplicate packets.

According to one set of embodiments, this feature can entail automatically discovering what network entities are deployed in core network 204, what the properties of those network entities are (e.g., IP addresses, etc.), and how the network entities are interconnected. Packet broker 206 can perform this discovery by, e.g., monitoring and analyzing the control and/or data traffic that is tapped from core network 204. The specific nature of the discovery process will differ depending on the type of the core network (e.g., a 3G network, an LTE network, etc.). Packet broker 206 can perform the discovery upon initialization, as well as on a continuous basis throughout its runtime (in order to detect newly added or removed entities).

Packet broker 206 can then use this core network information to facilitate its configuration as well as perform other functions. For example, in one embodiment packet broker 206 can automatically setup access control lists/filters based on the discovered network entities. This can include, e.g., default filters for forwarding traffic tapped from certain network entities to certain probes/tools, as well as filters for removing duplicate traffic, filters for forwarding traffic from newly added notes, and so on.

In another embodiment, packet broker 206 can group discovered network entities or zones in order to ease configuration management. This can help in steering traffic to corresponding zones to appropriate analytic probes/tools so that certain problems (such as duplicate packets) can be avoided.

In yet another embodiment, packet broker 206 can setup notifications/alerts when there are modifications in core network 204 (e.g., entities are added, removed, etc.). Packet broker 206 can then apply policies to update its configuration based on the core network modifications. This can be particularly useful if core network 204 is virtualized, since the configuration of the core network will likely change on a frequent basis in this scenario.

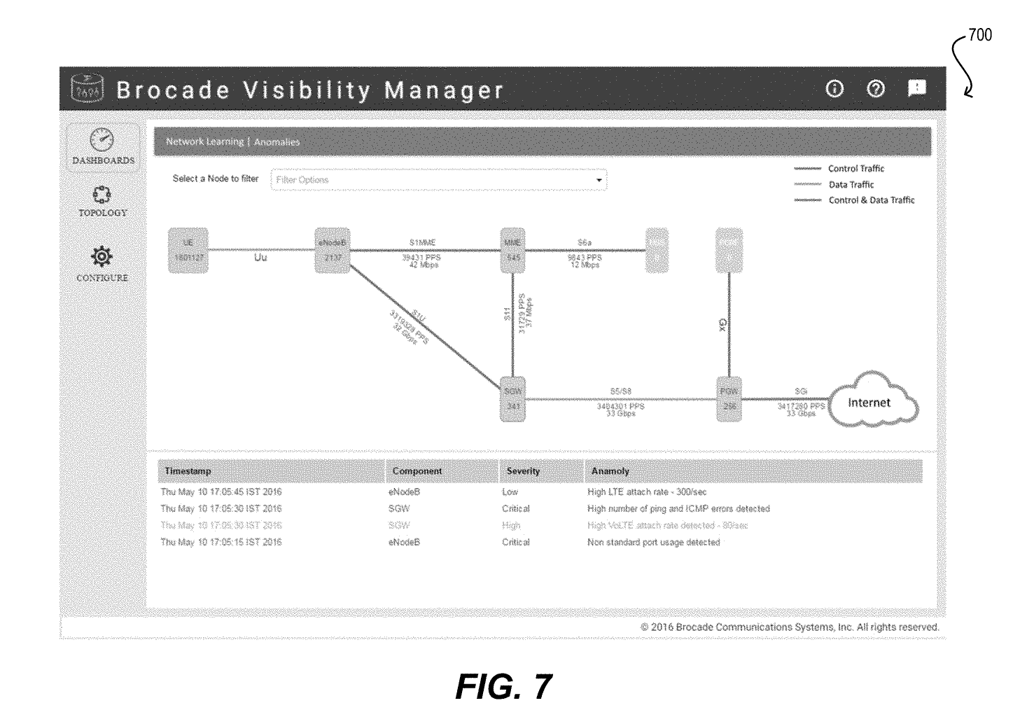

In yet another embodiment, packet broker 206 can provide the discovered network information to a tool (e.g., an SDN app running on an SDN controller) so that users can visualize the topology of core network 204. FIG. 7 depicts an example UI 700 that illustrates a visualization of a core network using such a tool according to an embodiment. In this tool, a user can view the entities and their connections/interfaces, and can filter the view based on types of entities (e.g., ENodeB, SGW, MME, PGW, HSS, AAA, etc.) and other criteria. A user can also view alerts/notifications pertaining to anomalies that are detected or predicted by packet broker 206 in accordance with the techniques described in the foregoing sections.

### 7. Example Network Device

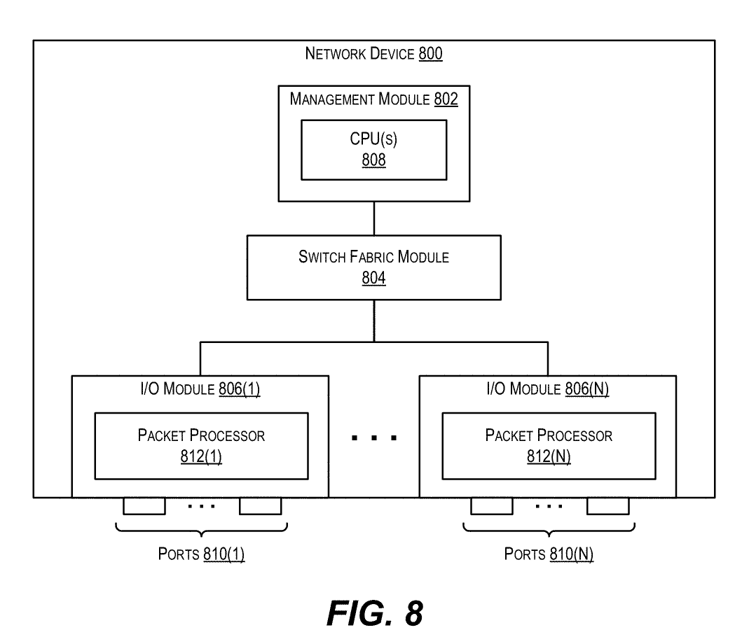

FIG. 8 depicts an example network device (e.g., switch and/or router) 800 in which certain embodiments of the present disclosure may be implemented. For example, in one set of embodiments, network device 800 may be used to implement packet broker 206 of FIG. 2 (either wholly or in part).

As shown, network device 800 includes a management module 802, a switch fabric module 804, and a number of I/O modules 806(1)-806(N). Management module 802 includes one or more management CPUs 808 for managing/controlling the operation of the device. Each management CPU 808 can be a general purpose processor, such as a PowerPC, Intel, AMD, or ARM-based processor, that operates under the control of software stored in an associated memory (not shown).

Switch fabric module 804 and I/O modules 806(1)-806(N) collectively represent the data, or forwarding, plane of network device 800. Switch fabric module 804 is configured to interconnect the various other modules of network device 800. Each I/O module 806(1)-806(N) can include one or more input/output ports 810(1)-810(N) that are used by network device 800 to send and receive data packets. Each I/O module 806(1)-806(N) can also include a packet processor 812(1)-812(N). Packet processor 812(1)-812(N) is a hardware processing component (e.g., an FPGA or ASIC) that can make wire speed decisions on how to handle incoming or outgoing data packets.

It should be appreciated that network device 800 is illustrative and many other configurations having more or fewer components than network device 800 are possible.

### 8. Example Computer System

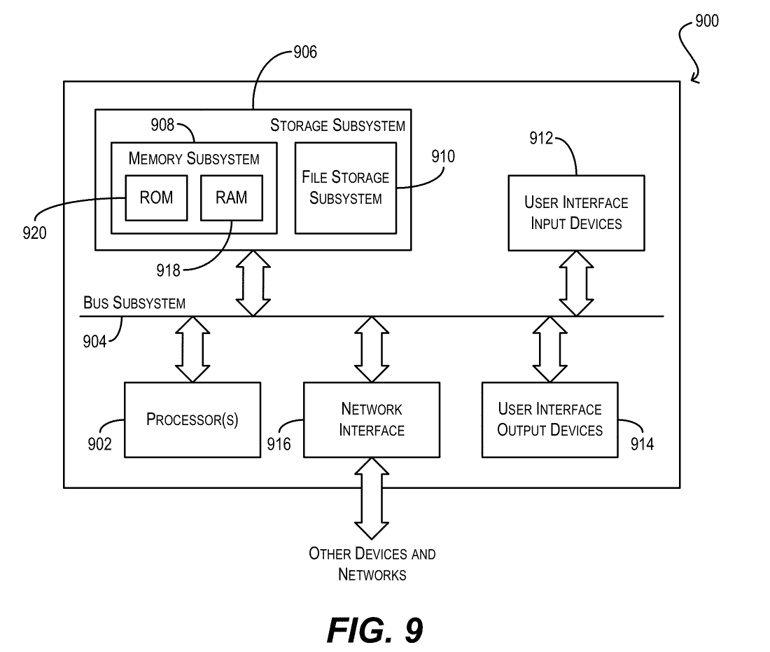

FIG. 9 depicts an example computer system 900 in which certain embodiments of the present disclosure may be implemented. For example, in one set of embodiments, computer system 900 may be used to implement packet broker 206 of FIG. 2 (either wholly or in part).

As shown in FIG. 9, computer system 900 includes one or more processors 902 that communicate with a number of peripheral devices via a bus subsystem 904. These peripheral devices include a storage subsystem 906 (comprising a memory subsystem 908 and a file storage subsystem 910), user interface input devices 912, user interface output devices 914, and a network interface subsystem 916.

Bus subsystem 904 can provide a mechanism for letting the various components and subsystems of computer system 900 communicate with each other as intended. Although bus subsystem 904 is shown schematically as a single bus, alternative embodiments of the bus subsystem can utilize multiple buses.

Network interface subsystem 916 can serve as an interface for communicating data between computer system 900 and other computing devices or networks. Embodiments of network interface subsystem 916 can include wired (e.g., coaxial, twisted pair, or fiber optic Ethernet) and/or wireless (e.g., Wi-Fi, cellular, Bluetooth, etc.) interfaces.

User interface input devices 912 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 900.

User interface output devices 914 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 900.

Storage subsystem 906 includes a memory subsystem 908 and a file/disk storage subsystem 910. Subsystems 908 and 910 represent non-transitory computer-readable storage media that can store program code and/or data that provide the functionality of various embodiments described herein.

Memory subsystem 908 includes a number of memories including a main random access memory (RAM) 918 for storage of instructions and data during program execution and a read-only memory (ROM) 920 in which fixed instructions are stored. File storage subsystem 910 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 900 is illustrative and many other configurations having more or fewer components than computer system 900 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
applying, by a packet broker in a visibility network, one or more machine learning models to network traffic that is replicated from a core network;
detecting, by the packet broker based on the applying of the one or more machine learning models, that a network traffic anomaly has occurred or is occurring in the core network; and
in response to the detecting, taking, by the packet broker, one or more predefined actions.

2. The method of claim 1 wherein the one or more machine learning models include a time-series model adapted to model changes in value of a core network parameter over time.

3. The method of claim 1 wherein the one or more machine learning models include a protocol language model adapted to model valid message exchanges or flows with respect to a particular network protocol in the core network.

4. The method of claim 1 further comprising, prior to the applying:
training, by the packet broker, at least a first machine learning model in the one or more machine learning models using historical traffic data collected from the core network.

5. The method of claim 1 further comprising, prior to the applying:
training, by the packet broker, at least a first machine learning model in the one or more machine learning models using live traffic data replicated from the core network.

6. The method of claim 1 wherein the applying comprises:
determining, from the network traffic replicated from the core network, an actual value of a core network parameter or criterion that is modeled by one machine learning model in the one or more machine learning models; and
determining, using the machine learning model, an expected value of the core network parameter or criterion.

7. The method of claim 6 wherein the detecting comprises:
determining that a discrepancy exists between the actual value and the expected value that exceeds a predefined threshold or reflects an inconsistency.

8. The method of claim 1 wherein the one or more predefined actions include:
steering network traffic from the core network that is deemed to be related to the network traffic anomaly to one or more analytic probes or tools.

9. The method of claim 1 wherein the one or more predefined actions include:
generating an alert for a network administrator.

10. The method of claim 1 wherein the one or more predefined actions include:
metering network traffic from the core network that is deemed to be related to the network traffic anomaly.

11. The method of claim 1 further comprising:
predicting, by the packet broker based on the applying of the one or more machine learning models, that another network traffic anomaly will occur in the core network at a future point in time; and
in response to the predicting, taking, by the packet broker, one or more additional predefined actions.

12. The method of claim 11 wherein the predicting comprises:
retrieving a plurality of historical values of a core network parameter that is modeled by one machine learning model in the one or more machine learning models;
fitting the plurality of historical values to a linear regression model; and
extrapolating a value of the core network parameter at the future point in time.

13. The method of claim 12 wherein the predicting further comprises:
comparing the extrapolated value of the core network parameter at the future point in time with a predefined threshold.

14. The method of claim 1 further comprising:
automatically discovering, by the packet broker, information regarding the core network, the information including network entities in the core network and interconnections between the network entities; and
facilitating, by the packet broker, its configuration based on the discovered information

15. A non-transitory computer readable storage medium having stored thereon program code executable by a packet broker in a visibility network, the program code causing the packet broker to:
apply one or more machine learning models to network traffic that is replicated from a core network;
detect, based on the applying of the one or more machine learning models, that a network traffic anomaly has occurred or is occurring in the core network; and
in response to the detecting, take one or more predefined actions.

16. The non-transitory computer readable storage medium of claim 15 wherein the one or more predefined actions include:
steering network traffic from the core network that is deemed to be related to the network traffic anomaly to one or more analytic probes or tools.

17. The non-transitory computer readable storage medium of claim 15 wherein the program code further causes the packet broker to:
predict, based on the applying of the one or more machine learning models, that another network traffic anomaly will occur in the core network at a future point in time; and
in response to the predicting, take one or more additional predefined actions.

18. A packet broker comprising:
a processor; and
a non-transitory computer readable medium having stored thereon program code that, when executed by the processor, causes the processor to:
apply one or more machine learning models to network traffic that is replicated from a core network;
detect, based on the applying of the one or more machine learning models, that a network traffic anomaly has occurred or is occurring in the core network; and
in response to the detecting, take one or more predefined actions.

19. The packet broker of claim 18 wherein the one or more predefined actions include:
steering network traffic from the core network that is deemed to be related to the network traffic anomaly to one or more analytic probes or tools.

20. The packet broker of claim 18 wherein the program code further causes the processor to:
predict, based on the applying of the one or more machine learning models, that another network traffic anomaly will occur in the core network at a future point in time; and
in response to the predicting, take one or more additional predefined actions.
